(19) United States
(12) Patent Application Publication
(10) Pub. No.: US 2005/0235017 A1
(43) Pub. Date: Oct. 20, 2005

(54) System and method for high availability of data in a disaster recovery system

(76) Inventor: Jeff Ashman, Layton, UT (US)

Correspondence Address: MORRISS O'BRYANT COMPAGNI, P.C., 136 SOUTH MAIN STREET, SUITE 700, SALT LAKE CITY, UT, 84101, US

(21) Appl. No.: 10/825,073

(22) Filed: Apr. 15, 2004

(51) Int. Cl. G06F 17/30

(52) U.S. Cl. 707/204

(57) ABSTRACT

A method of performing a transaction-level audit, wherein the audit identifies individual transactions on a backup system that are different from those on a production system that utilizes remote journaling in order to re-create a production journal receiver on a backup system, wherein the re-created production journal receiver is compared with a backup journal receiver on the backup system, and wherein the backup journal receiver is created from a backup database file that is used to generate a backup journal file that is then used to generate the backup journal receiver.

### BACKGROUND OF THE INVENTION

1. Field Of the Invention

This invention relates generally to disaster recovery of computer systems. More specifically, the present invention pertains to a system and method for improved protection of data, wherein the data is already being protected by a high availability backup system, and wherein the system is improved by implementing a new backup model that results in more reliable data backup, which in turn results in faster system recovery when a failure in a primary storage system occurs.

2. Description of Related Art

One of the consequences of the rapid growth of the computer industry and the Internet is the equally rapid growth in the volume of data that is being stored in databases. Unfortunately, the old practice of relying on daily database backups is no longer adequate for many reasons. For example, many thousands of transactions take place daily at many financial institutions. It would be impossible to remain in business if the transactions of even a single day were in jeopardy of being lost because of failure of a data storage device.

While redundancy within a data center is now a common practice, this does not solve the problem if an entire site goes down. This is because a business might be forced to restore a previous night's backup, thus losing an entire day of transactions in the process. Thus when a recovery from an old backup is performed, the real damage in terms of business applications is extended by days or even weeks because internal users, customers, suppliers and partners will be required to recapture the lost transaction data.

Contingency planning professionals who are responsible for critical on-line database applications running on mainframes are no doubt familiar with technologies that can be used to protect valuable data. These strategies include disk mirroring, electronic vaulting, and remote journaling.

The state of the art in disaster recovery, including system backup, begins with an examination of how downtime can be reduced for computer systems. The disaster recovery industry uses two terms to describe different levels of protection for a mainframe computer system. High availability is described as a system for replicating critical data and system objects on a near real-time basis, typically to another computer, so that if the main or production computer fails, users will be switched quickly to the backup system in order to resume their work. With a high availability solution, some tasks that normally cause planned downtime are automatically eliminated because they can simply be performed directly on the backup system. For example, daily tape backups can be performed on the production system while users are seamlessly routed to the resources of the backup system. Once the backup is complete, the production system and the backup system are then brought into synchronization and users are again seamlessly routed back to the production system.

The next level of data protection is described as continuous availability. Continuous availability takes system availability much further by assuring that downtime is eliminated as nearly as possible in all circumstances; not just system failures or disasters, but any planned event that would normally require downtime. These circumstances include file reorganizations; hardware, software and operating system upgrades; system migrations; and new software installations. To achieve true continuous availability, a combination of availability products is typically required.

An important development in data backup was the introduction of the concept of remote journaling as mentioned above. Remote journaling is the process of securing transaction logs or journals at a remote location. These logs and journals are used in the event of a disaster to recover transactions and database changes that occurred after the most recent backup.

This concept of remote journaling can be demonstrated. FIG. 1 shows a typical prior art system for data backup in a high availability system. There are generally going to be two sides of this system, a production system 10, and a backup system 12. The production system 10 is the active system where all data changes are being made in real time by users of the system. Such data changes would include all the modifications to the data that are being transacted by users of the computer system. Such changes are typically being made to data stored in a database in some storage device. These changes would include adding new records, deleting existing records, modifying existing records, etc.

The database file is identified as the communication file 14. The communication file 14 sends information to a production journal 16. The production journal 16 transmits information to a journal receiver 18 that performs the function of retaining/storing database transactions. It is from the journal receiver 18 that a data harvest 20 can be performed.

From the data harvest 20, a filtering function 22 is often performed. A filtering function 22 refers to the elimination of log or journal records that are not needed for remote recovery. For example, some database systems write statistical and trace data to the logs and, in terms of the remote journal, these can be safely discarded. Furthermore, some databases may not need to be recovered to the end of the log. Thus, logging activity related to these less critical databases can be filtered out.

The remaining data is then prepared for transmission to the backup system 12 that is typically off-site. A communications file 26 on the backup system 12 receives the data transmitted from the communications file 24 on the production system 10. The data includes a copy of entries from the production journal receiver 18 so that the backup system 12 can perform an apply process 28. The apply process 28 makes changes to a backup file 30 using information from the production journal receiver 18. It should be remembered that the explanation above is a very simplified explanation of the process, and there are variations that are all within the scope of the system and process described in FIG. 1.

It is also noted that the production system 10 and the backup system 12 may perform integrity checks of the data using cyclical redundancy checking (CRC). However, performing CRC is a substantial drain on processing power of the production system 10. Remote journaling has enabled this step to be performed on the recreated database file stored on the backup system 12 to thereby reduce processing overhead on the production system 10.

To complete the explanation of the use of remote journaling in disaster recovery, it is useful to make the following observations. Logging and journaling occur at the same physical site where the database of the production system 10 resides. If a disaster strikes, the logs are lost along with the database. Remote journaling thus provides a way of getting the log and journal data to a remote site, over a communications link, so that disaster recovery can use the same database recovery processes that might be used in local site failure scenarios.

Logs and journals are combined with full database backups to yield a database recovered to a recent point in time. How recent this point will be is determined by how the remote journaling is accomplished. There are two basic methods of remote journaling being employed today. Log and journal data can be sent in batches, as separate and distinct files, or they may be communicated continuously in a stream using buffering software.

Some companies make extra copies of their log data as the logs are being archived (in some cases every hour) and then send these files off-site using some electronic file transfer technology. These remote copies of log or journal files are then used in disaster recovery to improve the quality of the databases being recovered. However, transactions occurring in the hour or so prior to a disaster would not be reflected in the recovered database. The reason for this is that log data containing evidence of these transactions has not yet been archived at the local site, much less sent off-site.

The advantages of remote journaling are clear. However, FIG. 1 shows that in the prior art, the CRC process is performed on the database file 30 that is created in the backup system 12. The only thing that the administrator learns from performing the CRC process is whether or not the database file 30 matches the database file 14 of the production system 10. Disadvantageously, this CRC process cannot be considered to be an audit of the data. This term as used in the present invention refers to an audit as verification of the accuracy of each transaction that was stored in the journal. In other words, an audit identifies the individual transactions that are in error, not just whether or not an error exists somewhere in the backup database file 30.

Accordingly, what is needed is a method of performing an audit on data in the backup system 12, wherein the audit can identify specific transactions that contain an error.

### BRIEF SUMMARY OF THE INVENTION

It is an object of the present invention to provide a method of performing a transaction-level audit.

It is another object to provide a method of performing a transaction-level audit, wherein the disaster recovery system utilizes remote journaling.

It is another object to provide a method of performing a transaction-level audit, wherein the audit can identify individual transactions that are different from those on a production system.

It is another object to provide a method of performing a transaction-level audit, wherein the audit can not only identify individual transactions that are different from those on a production system, but can also perform repairs without resynchronization.

In a preferred embodiment, the present invention is a method of performing a transaction-level audit, wherein the audit identifies individual transactions on a backup system that are different from those on a production system that utilizes remote journaling in order to re-create a production journal receiver on a backup system, wherein the re-created production journal receiver is compared with a backup journal receiver on the backup system, and wherein the backup journal receiver is created from a backup database file that is used to generate a backup journal file that is then used to generate the backup journal receiver.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a block diagram of a prior art disaster recovery system not utilizing remote journaling.

I wonder if it might be useful here to include a diagram of a disaster recovery system utilizing remote journaling without the present invention.

FIG. 2 is a block diagram of a first embodiment that is made in accordance with the principles of the present invention.

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

The presently preferred embodiment of the invention is a method of utilizing remote journaling to perform a transaction-level audit. The present invention is also a method of reducing overhead on a production system by performing the audit entirely on a backup system, eliminating a need to perform a CRC process on a production system, eliminating the need to perform a data harvest on the production system, and eliminating the need to perform filtering of data from the resulting data harvest.

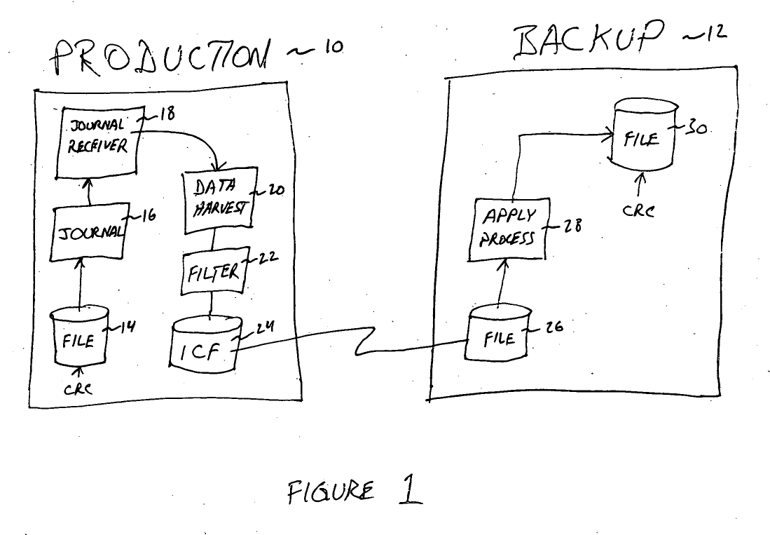

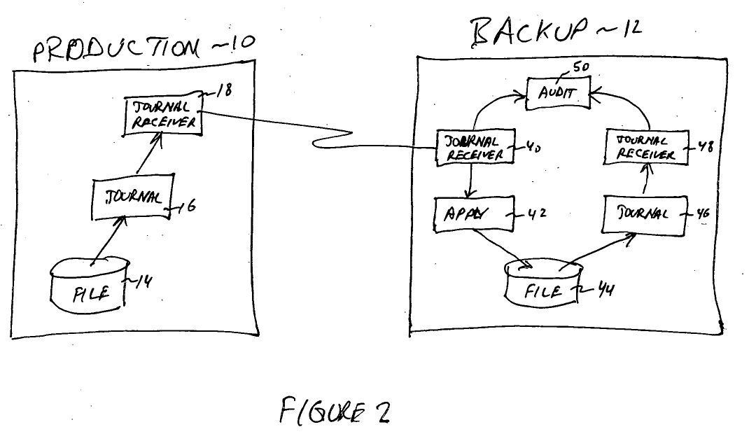

The first embodiment of the present invention is illustrated as a block diagram in FIG. 2. FIG. 2 first illustrates that the overhead on the production system 10 and the backup system 12 has been significantly reduced because there are only two processes being performed. First, the database file 14 is utilized as shown in FIG. 1 to create a production journal 16. The production journal 16 is a record of all transactions being performed on the database file 14. The next step is to transfer the production journal 16 to the journal receiver 18. The journal receiver 18 performs the function of retaining/storing database transactions. Data is transferred from the journal receiver 18 directly to a journal receiver 40 in the backup system 12. Note that the prior art does not use a journal receiver.

An apply process 42 is performed in order to create a database file 44. The database file 44 should be an exact copy of the database file 14 on the production system 10.

The next steps are critical to the present invention. First, the database file 44 is used to create a remote journal 46. This remote journal 46 is then used to create a journal receiver 48. The journal receiver 48 on the backup system 12 should be the same as the journal receiver 18 on the production system 10. This is verified in an audit 50, or comparison of these journal receivers 18, 48. However, the comparison process is performed locally on the backup system 12 because the journal receiver 18 has been copied to journal receiver 40 on the backup system.

Through this comparison of the original journal receiver 18, 40 with the recreated journal receiver 48, it is possible not only to determine that the database file 44 is different from the database file 14, but also to know exactly which transaction is different. A different transaction would have created an error in the database file 44.

In this first embodiment of the present invention, the intent is to identify the transactions that are in error. It should now be understood why this audit is a significant improvement over the prior art. However, the present invention is also capable of providing additional benefits.

Specifically, an alternative embodiment of the present invention is the next logical step in the evolution of disaster recovery. That next step is to correct the entry in the database file 44 so that the database file 44 on the backup system 12 is identical to the database file 14 on the production system 10.

To accomplish error correction, there is another feature of the present invention for performing the transfer of data between the production system 10 and the backup system 12. By harnessing the power of remote journaling, the present invention is able to transmit data changes between the production system 10 and the backup system 12 at an operating system level. Data transfer is performed in machine code, for extraordinary data replication speed. This means that even if many data transactions are being performed in the production system, data is still able to be moved from the production system 10 to the backup system 12 within milliseconds. In fact, the amount of data latency (the time between the creation of a transaction on the production system 10 and the writing of the transaction on the backup system 12) is so negligible that if the production system 10 suddenly fails or the network drops, it is likely that all transactions that occurred up to the very moment of failure will have already reached the backup system 12.

It should also be apparent that simply because the present invention is able to virtually eliminate the loss of data because journal entries are updated so rapidly on the backup system 12, that fact does not eliminate the need to then verify the integrity of the transactions that have been recorded in the production journal 16, and recreated in the backup journal 46.

It is also noted that because the present invention incorporates remote journaling, it uses virtually none of the processing power of the production system that is normally required for a separate overhead processes, such as the proprietary “data harvest” process as shown in FIG. 1.

It is to be understood that the above-described arrangements are only illustrative of the application of the principles of the present invention. Numerous modifications and alternative arrangements may be devised by those skilled in the art without departing from the spirit and scope of the present invention. The appended claims are intended to cover such modifications and arrangements.

1. A method for verifying accuracy of a database file in a backup system by performing a transaction level audit, said method comprising the steps of:
(1) transmitting a production journal receiver from a production system to a backup system;
(2) creating a backup database file from the production journal receiver;
(3) generating a backup journal in the backup system from the backup database file;
(4) generating a backup journal receiver from the backup journal; and
(5) comparing the backup journal receiver and the production journal receiver to thereby identify differences therebetween.

2. The method as defined in claim 1 wherein the method further comprises the steps of:
(1) generating a production journal from a database file on a production system; and
(2) generating the production journal receiver from the production journal.

3. The method as defined in claim 2 wherein the step of creating a backup database file from the production journal receiver further comprises the step of performing an apply process on the production journal receiver that is received from the production system.

4. The method as defined in claim 3 wherein the method further comprises the step of identifying errors in the backup database file at a transaction level from the comparison of the backup journal receiver and the production journal receiver.

5. The method as defined in claim 4 wherein the method further comprises the step of repairing entries in the backup database file by using the identified errors.

6. The method as defined in claim 5 wherein the method further comprises the step of repairing incorrect entries in the backup database file without having to resynchronize the backup database file.

7. The method as defined in claim 6 wherein the method of performing an audit of a database file in a backup system is characterized by reducing processor overhead on the production system by performing the audit entirely on the backup system.

8. The method as defined in claim 6 wherein the method of performing an audit of a database file in a backup system is characterized by reducing processor overhead on the production system by eliminating a need to perform a cyclical redundancy check process on the production system.

9. The method as defined in claim 6 wherein the method of performing an audit of a database file in a backup system is characterized by reducing processor overhead on the production system by eliminating a need to perform a data harvest on the production system.

10. The method as defined in claim 6 wherein the method of performing an audit of a database file in a backup system is characterized by reducing processor overhead on the production system by eliminating a need to perform filtering of data from the resulting data harvest.

11. The method as defined in claim 6 wherein the method of performing an audit of a database file in a backup system is characterized by reducing processor overhead on the backup system by making more efficient the running of a cyclical redundancy check process on the backup system.

12. The method as defined in claim 1 wherein the method further comprises the step of transmitting data changes in the production journal receiver to the backup system at an operating system level.

13. The method as defined in claim 12 wherein the step of transmitting data changes at the operating system level further comprises the step of transmitting data in machine code to thereby reduce latency between the production system and the backup system.

14. The method as defined in claim 13 wherein the step of reducing latency further comprises the step of performing data transfer at a relatively high rate of speed even if the production system is processing a large number of transactions.

15. A method for verifying accuracy of a database file by performing a transaction level audit without creating more overhead on a production system, said method comprising the steps of:
(1) transmitting production journal receiver entries from a production system to a backup system;
(2) re-creating a copy of a database file on the backup system from the production journal receiver entries;
(3) generating a backup journal receiver on the backup system from the copy of the database file; and
(4) comparing entries in the backup journal receiver with the entries from the production journal receiver to thereby identify differences therebetween.

16. The method as defined in claim 15 wherein the method further comprises the step of creating a journal receiver on the backup system from the production journal receiver entries received from the production system.

17. The method as defined in claim 16 wherein the method further comprises the step of performing an apply process on the journal receiver on the backup system to thereby re-create the copy of the database file on the backup system.

18. The method as defined in claim 17 wherein the step of generating the backup journal receiver on the backup system from the copy of the database file further comprises the steps of:
(1) creating a backup journal from the copy of the database file on the backup system; and
(2) creating the backup journal receiver on the backup system from the backup journal.

19. The method as defined in claim 18 wherein the method further comprises the step of identifying errors in the copy of the database file at a transaction level from the comparison of the backup journal receiver and the production journal receiver entries.

20. The method as defined in claim 19 wherein the method further comprises the step of repairing entries in the copy of the database file by using the identified errors.

21. The method as defined in claim 20 wherein the method further comprises the step of repairing incorrect entries in the copy of the database file without having to resynchronize the copy of the database file.

22. A method for auditing records in a backup database file without the need to harvest data from a production system, said method comprising the steps of:
(1) transmitting a production journal receiver from a production system to a backup system;
(2) applying the production journal receiver to thereby enter transactions into a backup database file;
(3) generating a backup journal receiver from the backup database file; and
(4) comparing the backup journal receiver and the production journal receiver to thereby perform an audit of records in the backup database file.
